(19) United States
(12) Patent Application Publication
(10) Pub. No.: US 2025/0031632 A1
(43) Pub. Date: Jan. 30, 2025

(54) LAMINAR AIR MOVEMENTS FOR CONTROLLED-ENVIRONMENT AGRICULTURE RECEIVING NUTRIENTS VIA FOG ENABLING MUSHROOM AND PLANT GROWTH IN SAME INFRASTRUCTURE

(71) Applicant: Cosmic Eats, Inc., Cary, NC (US)

(72) Inventors: Angela Turner, Apex, NC (US); Benjamin Greene, Swannanoa, NC (US); Sheetal Shah, Cary, NC (US)

(73) Assignee: Cosmic Eats, Inc., Cary, NC (US)

(21) Appl. No.: 18/784,976

(22) Filed: Jul. 26, 2024

Related U.S. Application Data
(60) Provisional application No. 63/515,953, filed on Jul. 27, 2023.

(51) Int. Cl. A01G 9/24

(52) U.S. Cl. CPC A01G 9/246

(57) ABSTRACT

A controlled environment agriculture (CEA) solution that utilizes a planar layer of flowing air across an indoor crop tray or other planar surface containing crops. The flow of air is coupled with applications of fog. Crops include plants and fungi. The fog (e.g., via fogponics) delivers moisture and other embedded nutrients to a set of crops. In embodiments, the nutrients, moisture level, and temperature of the fog are adjusted for the optimized crop growth. Different laminar motions of air affect movement of different fog compositions. Thus, an indoor farming shelving unit, crop tray, etc., functions as tunable microenvironments, upon which divergent plants/fungi are grown.

### PRIORITY

This is a U.S. non-provisional application that claims priority to U.S. Provisional Application No. 63/515,953 ('953 Provisional), filed Jul. 27, 2023, all of which are hereby incorporated by reference in their entirety as if fully set forth herein.

### FIELD OF THE EMBODIMENTS

The field of the invention and its embodiments relates to controlled environment agriculture (CEA), indoor farms, air flows, heating, ventilation, and air conditioning (HVAC), fog machines, fluid dynamics, and more particularly to laminar air movements for CEA receiving nutrients via fog enabling mushroom and plant growth in the same infrastructure.

### BACKGROUND OF THE EMBODIMENTS

Indoor farming, also known as controlled-environment agriculture (CEA), is a method of growing agricultural products indoors including fungi, herbs, vegetables, produce, medicals, cannabis, and mushrooms. Indoor farming is practiced on a large scale using growing methods and tools that include hydroponics, vertical farming, and artificial lighting systems. Enclosed facilities used in indoor farming create optimal growing conditions for farmers to grow a crop from seeds to harvesting stages in less time and with higher yields than conventional outdoor farming. CEA is all about precision as it controls multiple aspects of an environment including carefully managing temperature, humidity, light, CO2 levels, and the like. Indoor farming and/or CEA is often a subset of sustainable, environmental engineering.

One present challenge with indoor farming is cultivating both plants and fungi at the same time using the same infrastructure to create the desired growing conditions. That is, multi-cropping plants and mushrooms in the same indoor farming system is very hard to do without building a whole separate environment for the mushrooms. Fundamentally, different crops have divergent optimal growing conditions.

Plants and fungi are living organisms classified in different kingdoms and are part of divergent scientific branches. For example, botany is a branch of science that deals with plants and mycology is the study of fungus. To elaborate, plants are producers, using the energy of the sun to make seeds, cones, and spores to reproduce, while fungi are decomposers that break down decaying matter. Plants have chlorophyll and can produce their own food, while mushrooms are heterotrophs that eat ready-made organic material. Plants reproduce primarily by seeds, which are complex multicellular organisms containing embryos, while fungi reproduce through spores. Plants have roots, stems, and leaves, while fungi only have filaments which attach to the host. Fungi have chitin as a component of their cell walls instead of cellulose.

Indoor farming has generally not been able to handle concurrently growing both plants and mushrooms (e.g., a fungi) in a safe and optimal manner. Often, a concurrent presence of mushrooms alongside plants is an indication of a problem that is to be avoided.

Some conventional indoor growing methods/devices have utilized fog or mist to deliver moisture/temperature. As used herein, fog and mist are not necessarily interchangeable terms. Fog is typically under 50 microns. Mist is generally composed of larger droplets (˜50-100 microns). Mist can be more wasteful and more likely to pool in a growing area. Most mushroom growers are using mist sprayed via nozzles to raise the humidity in the mushroom growing environment.

Current methods for delivery of fog include delivery to plant roots via in-pot nozzles or atomizers. In the case of mushrooms (and other fungi), high pressure fog or mist is often delivered through overhead misters or ducting/piping (with misting holes). Thus, conventional application of mists and fogs to a growable is through a chaotic or turbulent application of fog/mist (e.g., you just spray it chaotically in a region proximate to a growable).

What is needed is a new, methodology for growing fungi and plants within the same system that minimizes a need for separation. Ideally, environmental factors for crop growth will be able to be controlled in a highly variable manner, while minimizing costs and maximizing efficiency.

### REFERENCES

JP7215984B2 purports to provide a mixed cultivation system that can preferably accelerate the growth of plants while reducing a cost spent on mushroom cultivation and plant cultivation.
KR1020160118802A relates to a multi-purpose plant cultivator and, more specifically, to a plant cultivator, wherein the indoor plant cultivator comprises all components capable of making an optimal cultivation environment for cultivating food, such as lettuce or mushroom.
U.S. Pat. No. 9,010,019B2 is for a plant air purifying enclosure, or “PAPE,” contained within an unconditioned space, either within or outside a building, containing therein a plant air purifier, which is used to purify air using plants and microbes growing therein.
JP62051929A relates to a method and device for cultivating mushrooms and plants. The disclosed system has two enclosed, separate environments. CO2 interchange occurs between these environments.
WO2019/224553A1 relates to the field of lighting and gas delivery supports for the use in indoor farming, and to systems using the same.
KR1020140102822A is directed to a plant factory container including: a housing having a machine room with a vent and at least one cultivation room; a set of beds located in the cultivation room; HVAC equipment arranged in the machine room; a duct in which air conditioned by the HVAC equipment.
US20220183240A1 discloses a symbiotic agricultural system includes a fungi growing environment and a plant growing environment. The symbiotic agricultural system includes a control system that controls airflow from the fungi growing environment to the plant growing environment based on a carbon dioxide level in the plant growing environment.
WO2023223020A1 is directed to a controlled environment agriculture system that is modular and configured for retrofit location in a pre-existing building structure into one or more multi-modal farm modules.
Other notable references include US20190133055A1, US20210161089A1, CN203251719U, KR200475073Y1, US20230345890A1, and the KINGFIT climate control machine all-in-one (e.g., NPL device commercially available and readily found via a web browser lookup).

These references are believed to largely represent the state of the art in CEA, especially for indoor farms providing a solution to grow both plants and fungi (e.g., mushrooms). None of the above are known to contemplate a use of laminar flows as a mechanism for selective environmental control of crops with divergent needs.

### SUMMARY OF THE EMBODIMENTS

Embodiments of the invention facilitate indoor agriculture of both plants and mushrooms (generically referred to as crops) via a controlled application of fog and a controlled delivery of air flow. One or both of the delivery/application of fog/air occurs as needed. The air flow is referred to herein as a laminar air movement. The disclosure sometimes refers, by shorthand, to the set of processes/systems that perform the delivery/application as a “laminar flow” of air and/or fog. Fog (or mist) can refer to a relatively thick cloud of tiny water droplets suspended in an atmosphere that typically obscures visibility. Visibility is not a primary concern with the laminar flows of nutrient-rich moisture directed at crops, as detailed herein. That said, the visible nature of fog can provide visual cues indicative of flow rate and direction, thus informing whether a laminar flow is proceeding in a planar fashion as desired. A laminar flow (or laminar air movement) is a concept in fluid dynamics where fluid particles move in smooth, parallel layers with minimal mixing between the layers. A laminar air flow of air can direct or cause movement of fog. The resulting fog movement will be controlled in velocity and direction. In a laminar air flow, air flows in parallel layers with minimal turbulence. A laminar flow, which is steady and streamlined, is contrasted with a turbulent flow, which is irregular.

In a controlled-environment agriculture (CEA), crops (e.g., a generic term for plants and fungi grown indoors), are often grown within a crop rack, which is a shelving unit including multiple stacked shelves, each supporting a crop tray, each tray including containers for multiple units of a crop (plant/fungi). (see FIGS. 4A, 4B, 4F, 4H, 4I, and 4J for some real-world examples, which are arrangements used by the inventors in developing this disclosure/innovation). Aspects of the invention provide a laminar flow of air and resultant movements of fog, which directionally travels across a horizontal plane, which provides moisture, temperature control, nutrients, and the like to crops in a crop tray on a given shelf. The tray or shelf controlled in such as fashion can be considered a microenvironment for tailored crop growth. The laminar flow of the air may be effectively constrained to affecting a single microenvironment. Different laminar flows moving different fog compositions can be applied on a shelf-by-shelf (and tray by tray) basis. In embodiments, this can occur with a relatively “open shelf,” which does not impose air/watertight barriers between different shelves or trays of a rack. The isolation of the fog via different laminar flows is significant enough that even substantially divergent crops, such as plants and fungi, can be grown on adjacent microenvironments, positioned on adjacent shelves or trays on the same shelf.

It should be understood that laminar flows need not be horizontal. Indeed, vertical hydroponic based growing arrangements can benefit from vertical laminar flows. In embodiments, vertically spaced planes of crops can be regulated/fed using vertical laminar flows of air and resulting movements of fog. Similarly, some CEA farming structures are not, practically speaking, layered shelving units and growth arrangements/structures are widely varied from each other, often to maximize available space.

Accordingly, one aspect of the disclosure is directed to a system/method that applies laminar flows of air and resulting controlled movements of fog to CEA. In the method, an indoor farm unit/structure is established (e.g., a farming shelf unit). This unit has a set of growth surfaces that include a first and a second one (e.g., different tunable microenvironments). Each of the growth surfaces is substantially planar and substantially parallel to each other. A first crop type grows on the first surface (e.g., growing fungi on one shelf/tray) and a second crop type grows on the second surface (e.g., growing plants in a plant tray on an adjacent shelf/tray). The CEA system is configured to customize environmental growth conditions for crops through a selection application of system configurable fog. That is, the CEA system produces and directs fog within various airflow structures. The resulting fog has variable temperatures, nutrient mixes, humidity levels, flow rates, fog flow on/off cycles, and the like. The first crop (e.g., fungi or plant) and the second crop (e.g., different type or growth phase of fungi or plant) have very divergent needs from each other, which are each satisfied at least in part through the application of tailored fog moved through tailored laminar flows of air. (Other divergent needs, such as light can be satisfied through CEA components not focused upon herein.) Thus, the system/method is said to produce configurable fog delivered via a controlled airflow, all tunable for either the first or second crop. For example, a first fog can have first fog adjustments for a first fog temperature, a first fog nutrient mix, and a first fog humidity. A second fog can have second fog adjustments for a second fog temperature, a second fog nutrient mix, and a second fog humidity. The disclosure (and even referenced background art) provides numerous means to make and effectuate these adjustments to fog through different structural arrangements and components. Regardless of mechanisms used (e.g., fan arrangements, heating elements, fog generation devices, filtration processes, condensation chambers, etc.), a first laminar flow of air applied to move a first fog consistent with the first fog adjustments is directed across the first surface (e.g., uniform layer of fog travels in a controlled velocity across the first crop sitting on a shelf/tray). A second laminar flow results in movement of a second fog consistent with the second fog adjustments is directed across the second surface. Despite the first crop being relatively proximate to the second crop, the first laminar flow and the first fog do not appreciably affect the second crop. As mentioned, the laminar flows constrain the fog and its movement to a specific plane or microenvironment through application of fluid dynamic principles. Likewise, the second laminar flow and the second fog do not appreciably affect the first crop. In embodiments, the second crop (e.g., a fungus) may be adversely affected by the first fog (tailored for plants) if the first fog was applied using a turbulent flow instead of being a laminar one. Similarly, the first crop would be adversely affected by the second fog were the second laminar flow turbulent instead of being laminar. That is, each microenvironment is functionally isolated from each other in part due to the laminar nature of the flows detailed herein.

Per an aspect of the disclosure, the system and method including the laminar flow of air can be used in controlled environment agriculture (CEA) for the hydroponic growing of plants together with the growing of specialty fungi. The system is especially useful to growers of specialty multi-crops who might want many different growing conditions to exist in a small space. The laminar air and fog delivery system is able to be used inside of an existing building, greenhouse, container, or other structure to create multiple microenvironments for the growth of crops within growing systems housed within the larger structure, container, or building. The laminar air and fog delivery system can be used to enable the growing of microgreens, root, shoot and fruit plant crops, and specialty mushroom crops. The system generates horizontal or vertical laminar air movement to support plant leaf health and to deliver fog to plant roots and/or mushroom fruiting bodies for nourishment.

The laminar fog and air flow system is designed to make it easy to grow mushrooms or plants interchangeably in any indoor growing environment. To support the growth of mushrooms in a conventional hydroponic set-up for plants, the laminar fog and air flow system was developed and tested in an ebb and flow indoor growing system that was being used to grow various crop plants to early seedling stage (microgreens) and mature stages (beets, radish, lettuces, and kale). Once the laminar fog and air flow system was installed, shelf positions (subsections or trays), were quickly changed over to grow mushrooms, or continued as plant growing subsections at the discretion of the lab manager. In addition to producing mushrooms anywhere in the system, we carried out tests to characterize the system.

As disclosed herein, the laminar air and fog delivery system can work with any vertical rack system including nutrient film technique (NFT) channel system (single or multiple vertical shelf levels), or ebb and flow hydroponic systems, or it can work with a vertically oriented tower system such as the ZIPGROW system. In the embodiment of a vertical rack system with one or more shelves (whether ebb and flow, or NFT), once in place the laminar air and fog delivery system creates tunable microenvironments, which are tunable on a shelf and tray basis. For example, each 2-foot by 4-foot plant tray or each set of 4 NFT channels on a shelf of a vertical farm rack (whether ebb and flow or NFT) or each set of 6 channels of a tower system might have its own plenum for air and fog laminar flow.

Further, each of the above subsections could receive air and/or fog with control over air speed, airflow and/or fog source location, relative humidity, and the ability to adjust temperature by several degrees from ambient to benefit fungal fruiting. Control over each tunable microenvironment enables plants or mushrooms to be grown on any shelf, tray, or tower channel grouping.

Additionally, the company PIPP HORTICULTURE produces a vertical rack that can be used for ebb and flow technique for indoor farms. The rack comes in sizes of 8-foot×4-foot, up to 16 foot high and each rack contains multiple shelves. Using the PIPP 8-foot×4-foot rack, a user of the laminar air and fog delivery system would be able to create up to four different microenvironments per shelf to support the growth of plants or mushrooms. In the PIPP rack scenario, the system would then be compatible with 2-foot×4-foot plant trays and many other dimensions of “drain trays” a type of plant tray typically utilized in indoor farms for ebb and flow hydroponic systems. However, as mentioned earlier, the system can be utilized in single shelf or vertical rack NFT systems or vertically oriented tower channel style hydroponic set-ups. The plant trays, channels or towers are made such that water can be pooled or delivered in a thin stream and drained back into a collection reservoir.

### BRIEF DESCRIPTION OF THE DRAWINGS

FIG. 1A shows a diagram of a fog and air flow system according to at least some embodiments disclosed herein;

FIG. 1B shows a diagram of a crop structure having a laminar flow of fog according to at least some embodiments disclosed herein;

FIG. 2A shows a diagram of an embodiment of a laminar air flow and fog delivery system according to at least some embodiments disclosed herein;

FIG. 2B shows a diagram of another embodiment of a laminar air flow and fog delivery system according to at least some embodiments disclosed herein;

FIG. 2C shows a diagram of a crop system according to at least some embodiments disclosed herein;

FIG. 2D shows a diagram of a plant tray receiving a laminar air flow of fog according to at least some embodiments disclosed herein;

FIG. 2E shows a diagram emphasizing solid state cooling according to at least some embodiments disclosed herein;

FIG. 3 depicts a computing infrastructure according to at least some embodiments disclosed herein;

FIGS. 4A and 4B each show an indoor farming rack according to at least some embodiments disclosed herein;

FIG. 4C shows piping for applying a flow of fog to a crop tray according to at least some embodiments disclosed herein;

FIG. 4F shows a shelving arrangement of crops according to at least some embodiments disclosed herein;

FIGS. 4H, 4I, and 4J each show an embodiment for a shelving arrangement of crops and air and fog flow elements according to at least some embodiments disclosed herein;

FIGS. 4K, 4L, 4M, 4N, 4O, and 4P shows various crops grown using the laminar flow system according to at least some embodiments disclosed herein; and

FIGS. 5A, 5B, 5C, 5D, 5E, 5F, 5G, and 5H show charts graphing data for implementation of the laminar flow system according to at least some embodiments disclosed herein.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Our disclosure establishes a planar layer of flowing fog, moving in one direction, across an indoor plant tray or other planar surface. The fog delivers moisture and other embedded nutrients to a set of crops or growables. In embodiments, the fog is temperature adjusted for the crops. Different flows of fog can exist across different planar surfaces, which includes horizontal and vertical ones. Different flows can be applied to different portions of a crop, such as a root structure or a leaf structure of plants, by focusing flows within different geometric planes or regions. Often, indoor crops are positioned in shelves within plant trays, which are horizontally supported in a planar fashion. Thus, each horizontal surface of each distinct tunable microenvironment (e.g., shelf, tray, etc.) can be subject to a specific laminar flow of fog.

Notably, growing crops indoors can require control over humidity and, for plant crops, control over the leaf boundary layer. A thick boundary layer can reduce the transfer of heat, carbon dioxide, and water vapor. A horizontal laminar flow of air can reduce boundary layer thickness, increase photosynthetic efficiency, and improve plant health. Vertical laminar air flow can also be helpful to thin the boundary layer, but most products that target vertical laminar air flow are geared for use high above a crop canopy or beneath it as helper products geared to maximize the efficiency of horizontal laminar flow products. While plants need canopy level airflow to remove a thick humid boundary layer from leaves, their roots require an excess of humidity. To grow diverse crops including plants and fungi it is essential to deliver humidity to targeted body structures of plants and fungi and to deliver a laminar flow of air over plant canopies.

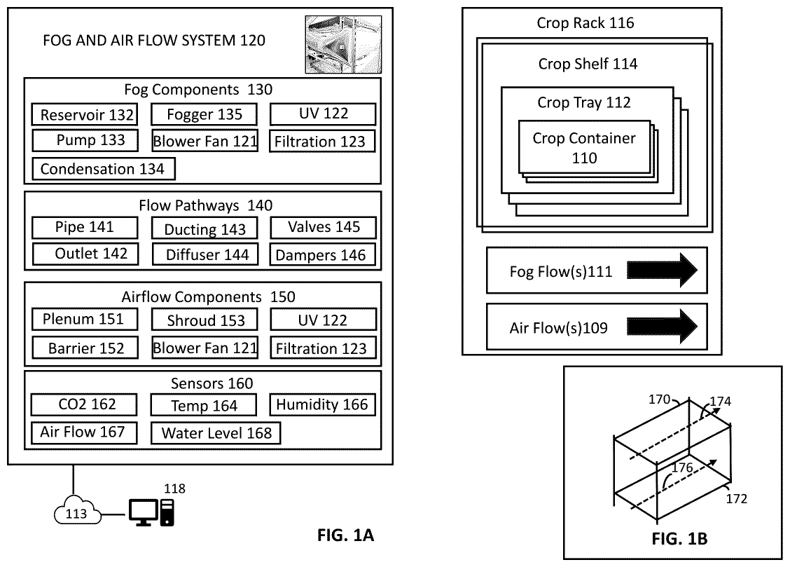

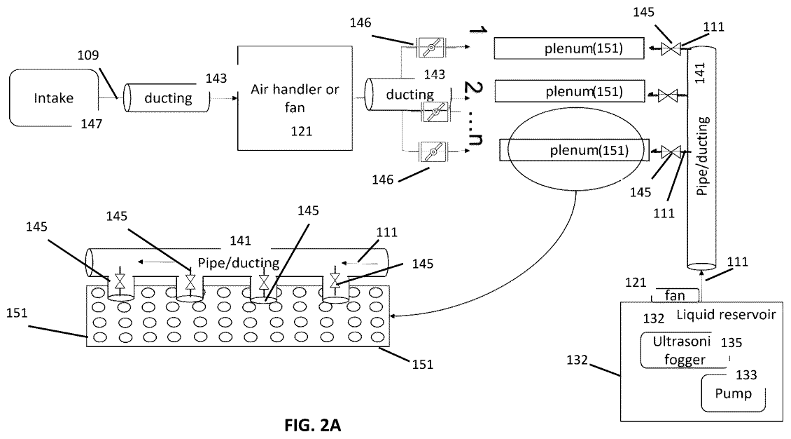

With reference to FIG. 1B, a model is shown of two parallel planar surfaces 170 and 172 within which crops grow. In one embodiment, surface 170 can represent a shelf 114 of a crop rack 116, and surface 172 can represent a different shelf 114. For simplicity, a “shelf” is the microenvironment shown in FIG. 1B. In another embodiment (not shown) surface 170 and 172 can exist side by side, where each represents a tunable microenvironment.

Air flows across each surface 170, 172 in a planar fashion, from end-to-end, in a laminar, non-turbulent manner. An output outlet (142) from which the laminar flow originates is positioned on one edge of each surface 170, 172. In some embodiments, an inlet from which the laminar flow returns to the flow pathways 150 of system 120 is positioned on an opposing edge of each surface 170, 172. In other embodiments, the flow is not captured by an inlet. That is, flows directionally occur across the surfaces 170, 172 in a laminar manner. Fog/mist travels per the air flow and settles until it dissipates, is absorbed by the crops on the respective surfaces 170, 172, and/or is condensed and drained back into a reservoir 132. In embodiments, characteristics of fog 111 and air flow 109 can be adjusted on a per crop basis. That is, the temperature, nutrients, humidity values, etc. provided by the fog via flow 174 can be tailored for a first crop (e.g., a plant), where a different temperature, nutrient mix, and humidity level can be provided by fog of flow 176 that is tailored for a difference, second crop (e.g., a fungi or different type of plant).

With reference to FIG. 1A, an indoor agriculture fog and air flow system 120 is shown that provides a laminar flow 109/111 of air/fog across crops (such as modeled by FIG. 1B), such as those in containers 110 of trays 112, on shelves 114 of a rack 116. System 120 includes a set of primary components for generating fog, customizing attributes of the fog, adjusting temperature of the fog, and the like. In embodiments, components of system 120 can be implemented utilizing commercially available components relating to airflow and agriculture based systems, such as components often found in heating, ventilation, and air conditioning (HVAC), CEA, and indoor farming.

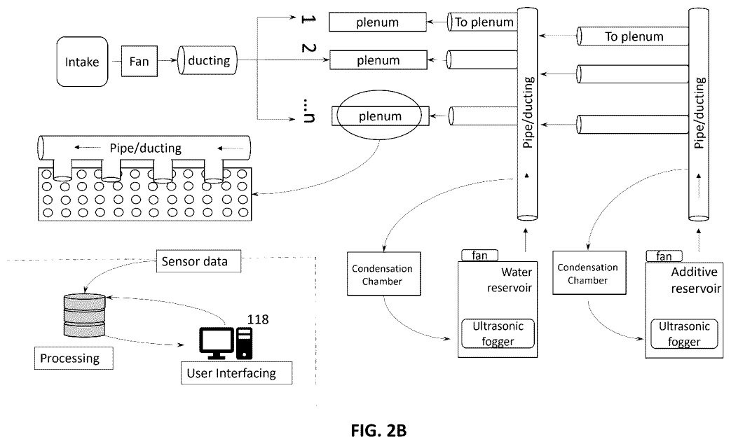

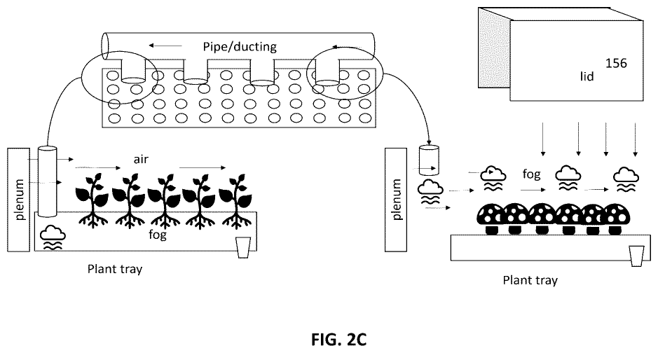

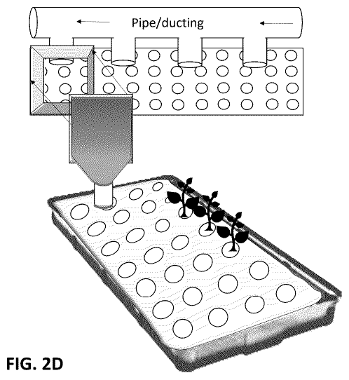

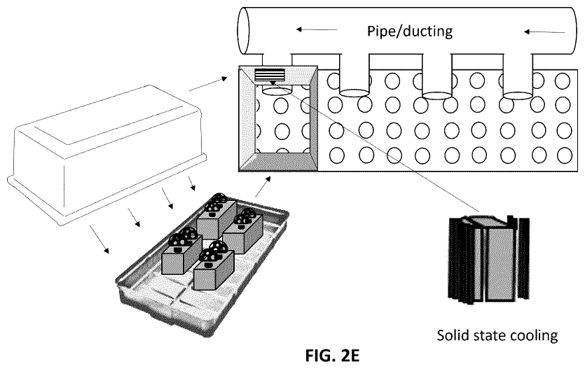

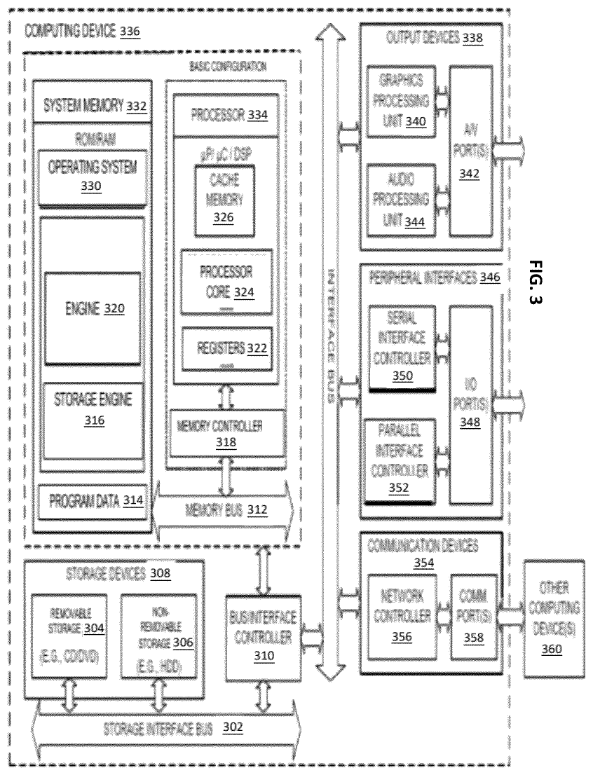

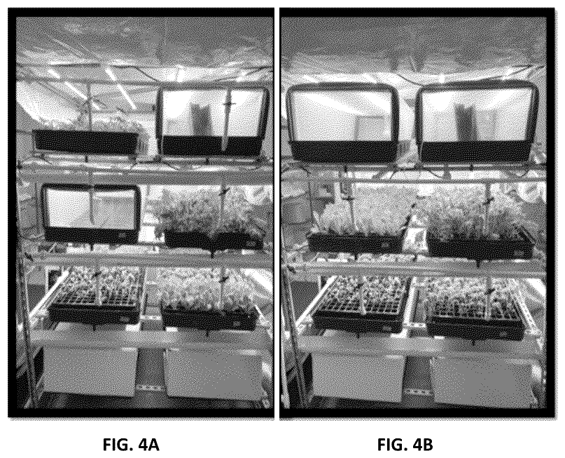

System 120 includes a set of fog components 130, which include a reservoir 132, a pump 133, a condensation component 134, a fogger 135, a blower fan 121, a UV component 122, and a filtration component 123, and/or the like. System 120 also includes flow pathways 140, airflow components 150, and a set of sensors 160. In embodiments, one or more computing devices 118 interfaces with the system, which may be communicatively linked via network 113. Various specific configurations of system 120 and parts thereof are illustrated by FIG. 2A, 2B, 2C, 2D, 2E, 4A, 4B, 4C, 4F, 4H, 4I, 4J, 4K, 4L, 4N, 4O, and 4P. FIG. 3 provides a model elaborating on components of device 118 and/or network 113.

The fogger 135, sometimes called a nebulizer, is a device that creates fog or mist. In a preferred embodiment, fogger 135 is an ultrasonic fogger the creates a fine mist using high-frequency ultrasound waves. These waves may be created by a small metal plate that vibrates at high frequencies, typically between 1.7 and 2.4 megahertz. Sound waves, outside a human hearing range, are created, which travel through water or other liquid based fluid. The fluid can include numerous additives, which can be tailored for different crops. Although ultrasonic foggers are preferred in embodiments, other fogger variants can be utilized.

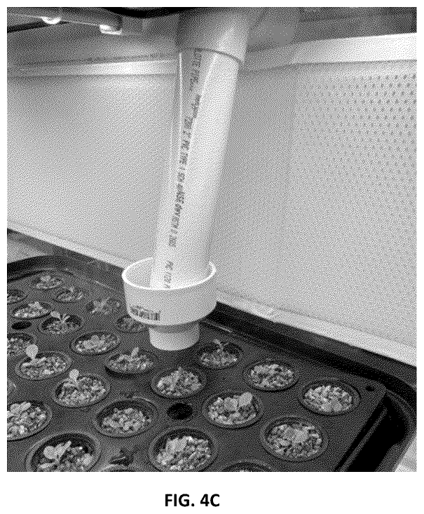

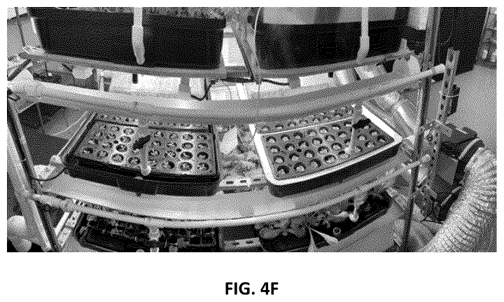

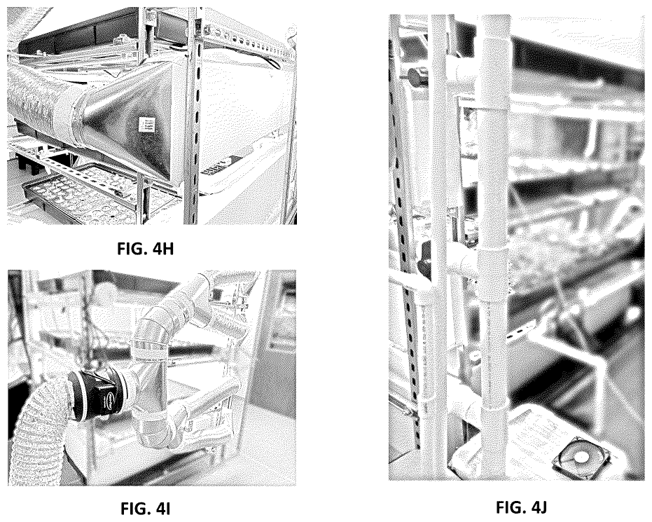

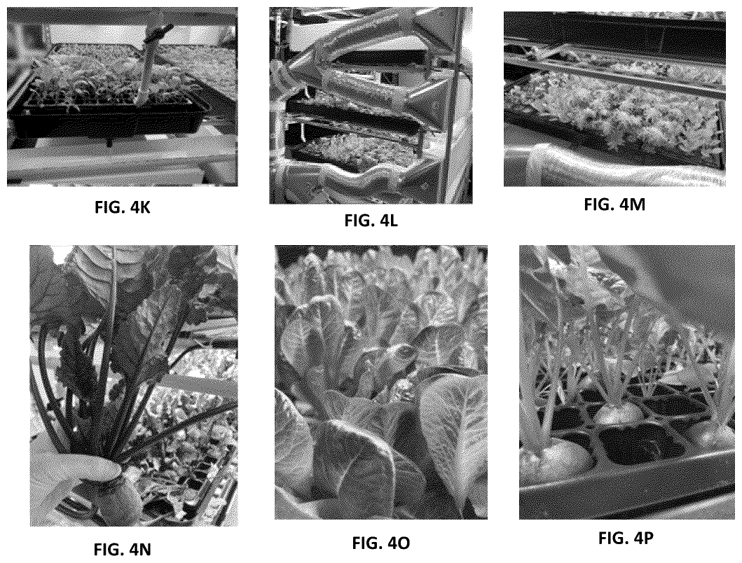

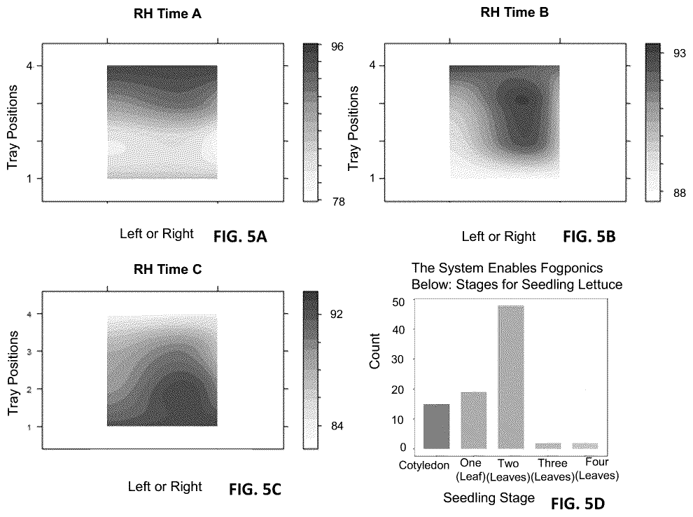

Generally, the fog produced by the fogger 135 can be generated per aeroponic, and more specifically through fogponics, techniques. Aeroponics is the process or science of cultivating plants in an air or mist environment. A principle of aeroponic growing entails suspending crops in a closed or semi-closed environment whilst spraying dangling roots and lower stems with a nutrient-rich water solution often in an atomized or sprayed form. Fogponics is a subset of aeroponics that uses a suspension of nutrient enriched water (e.g., fog) to deliver nutrients and oxygen to plant roots. Fogponics is often contrasted with organoponics, which uses soil and organic materials as a primary source of nutrients and traditional hydroponics, which uses a submersion of nutrient enriched water as a primary nutrient source. As noted by our arrangements (e.g., FIGS. 4A, and 4B), the delivery of nutrients via a laminar flow of fog can occur when crops are planted in a substrate such as pebbles, peat, rockwool or soil (e.g., in plant trays or other containers (110) or are suspended (fully or partially). Applicants note that fog used in fogponics is usually delivered to a growing chamber, which is a closed environment. The laminar flow used to deliver fog in the disclosure permits nutrient delivery via fog without requiring closed growing chambers. That is, fogponics is possible/feasible with the system. In embodiment, plant containers may have a lid, which is flush to any larger container or plant tray in which they are seated. In arrangements, it is also helpful to have germination lids as typically used in CEA.

Condensation components 134 include a set of reservoirs 132 or chambers that hold nutrient-rich mist or fog. The fog travels in system 120 through pathways 140. Components 124 can be positioned at various locations in system 120 to ensure laminar flows of fog 111 remain isolated to the planar shelves and/or surfaces to which they are intended, which differs from diffusing fog within a closed growing chamber.

Temperature control components include a thermostat, a heating unit, and cooling elements. In embodiments, conventional HVAC components, such as a blower fan 121 are utilized as temperature control components. Temperature control components can adjust a temperature of air and the fog itself.

Filtration components 123 can include water filters applicable to water and reservoirs that contain liquids used for fog generation as well as air filters applicable to temperature adjusted air passing through pathways 140. Water filters (123) can include reverse osmosis and carbon filter based components as well as screens and sediment filters.

UV components 122 can emit ultraviolet (UV) rays with germicidal properties to neutralize bacteria, viruses, molds, and other harmful airborne particles.

Additives include essential nutrients for crops, such as calcium, nitrogen, phosphorus, potassium, magnesium, sulfur, and zinc. Further, additives can alter the resulting nutrient profile of the crops. Further, additives can be used to adjust a pH level of fog, which is typically within a range above 5.0 and below 7.0. Different crops have divergent optimal nutrient needs.

Fog flow pathways 140 include components controlling/containing generated fog and related air. Pathways 140 are distinguished from components affecting an airflow rate, direction, or mechanism, which are performed by components 150.

Pipe 141, ducting 143, valves 145, outlets 142, diffusers 144, and dampers 146 are components used for directing the fog from one location to another. The outlets 142 work together to create a laminar flow of fog along a designated plane. Conventional AC ducting, including plenum can be among the components of pathways 140 as can be PVC piping, and HVAC hoses. That is outlets 142 that funnel fog types directly into plant root zones may be funnel shaped, round pipes or they may be shaped like hair dryer attachments such as diffusers or straightener attachments to further localize the fog application.

Airflow components 150 include plenum 151, barrier 152, shroud 153, blower fan 121, UV components 122, filtration components 123, and the like. In embodiments, airflow barriers 152 can be semi-opaque and block light as well as air flow.

Sensors 160 detect and report a value for a system of the system 120 and/or environmental states relevant to system 120. Sensors 160 can include CO2 sensors 162, temperature sensors 164, humidity sensors 166, airflow sensors 167, water level sensors 168, pH sensors, timing sensors, and the like.

In one embodiment, sensor readings and/or adjustable system 120 settings can be presented upon and/or changed from a connected computing device 118. Computer device 118 can include one or more servers (e.g., a controlled-environment agriculture (CEA) server) running appropriate agricultural software, which also controls the laminar air flow and movement of fog across the crops as detailed herein. In embodiment, computing device 118 can include one or more desktop or laptop computers, tables, smart phones, and the like. In embodiments, the computer (sensors 160 and actuators of system 120) are connected to a network, which is connected to an internet or intranet. In other embodiments, the computer device 118 can be a dedicated electronic device having control panels and display elements for functions detailed herein.

Crops include plants and fungus in one embodiment. Each unit of a crop can be placed in a crop container 110. A set of crop containers can form a crop tray 112, one or more trays 112 can be positioned on a crop shelf 114. In embodiments, a crop tray 112 can be a lowest practical level at which to implement a tunable microenvironment. Multiple vertically stacked shelves 114 can form a crop rack 116. Such an arrangement is illustrated in FIG. 4A, 4B, 4F, FIG. 4H, FIG. 4I, and FIG. 4J. In other embodiments (see FIG. 4C,) a platform or surface can be used for crops and/or crop trays without requiring stacked shelves 114. In other configurations, single containers including one or more crops can be utilized. Regardless of the arrangement, crops, and environments proximate to them are intentionally subjected to laminar movement of fog and air.

Referring to FIG. 2A, a setup is shown that includes an intake with ducting to an air handler or fan, which branches to further ducting and a set of plenum 151, each connected to a pipe/ducting 141/143, which is connected to a reservoir including a fogger 135 and may include a pump 133. In one embodiment, a float valve, sensor, or other method to deliver water to the reservoir can be used. The various plenum are connected to pipes/ducting, which convey flows of fog to crop trays 112. Various components of FIG. 2A are labeled with numbers consistent with FIG. 1A, which is the case for various other figures in the disclosure. In one prototype consistent with FIG. 1A, a laminar air flow was presented to two levels of planting beds and two levels of fungi with each level being 6 feet by 4 feet of planted area. Fog is able to be supplied via a PVC pipe having a two inch diameter outlet located in front of a plenum (see FIG. 4C).

Referring to FIG. 2B, a model of FIG. 2A has been expanded to show an acquisition of sensor data and its processing. Further, additional reservoirs and foggers are illustrated in FIG. 2B. As illustrated, embodiments of the laminar fog and air flow system (120) consists of fans for pulling air into a series of ductwork which lead to plenums for air and/or fog to be distributed to crops. Fog is generated in FIG. 2B from two reservoirs (132) and fans are used to move the fog through a series of pipes 141 to deliver water fog and/or fog containing additives. In some embodiments, a solid-state cooling device may be installed to cool fog and air as it is delivered (See FIG. 2E). Software running on computing device 118 enables manual or automated control of the conditions to create microenvironments.

The laminar air and fog delivery system 120 shown in FIG. 2B can operate independently of a building's HVAC system. In one embodiment, air that is pulled into and moved through the system can be sourced from carbon or oxygen rich sections of the indoor farm or facility. In another embodiment, the air can be sourced from outside the building. The laminar air and fog delivery system 120 can optionally be tied into an air handling system that already comprises or forms part of an air handling system of a building structure. If the system is tied into an air handling system of a building structure, then air sourcing will be from that air handling system. Fans pull air into the system's ducting where it is delivered to the plenums.

Once air is pulled into the laminar air and fog delivery system 120 by the fan(s), it may go through a series of HEPA and ULPA or other filters to clean out debris and microbial pathogens. Air may also be exposed to UV (122) lights for the purposes of further cleaning as it passes through the main ducting 143 on its way to the plenums 151 for distribution. At the plenums 151, air will encounter a series of dampers, and, in one embodiment, each 2-3-foot section will enable varied degrees of opening or closing of plenum vent holes to control the air speed and amount being blown horizontally into the growing volume. Dampers and vent opening are controlled by the control system software. Air speed can be set to automatically adjust for crop and growth stage or can be manually adjusted. The air speed supports air flow needed for healthy plant growth from germination to maturity and provides air flow for CO2 clearing and enables the delivery of fog in a laminar flow to mushroom fruiting bodies.

Fog generation: In one embodiment, fog is generated in a liquid reservoir (132) via ultrasonic fogger (135) discs and pushed out of the reservoir and into a pipe 141 by fans. Both ultrasonic fogger(s) and fans (on/off) are responsive to relative humidity (RH) of the environment they supply. Sensors 160 in each microenvironment report RH and compare to set point recipe. The highest RH setpoint for a microenvironment section, a 2-3-foot subsection on a shelf such as a 2-foot-wide drain tray for example, dictates whether the ultrasonic foggers 135 and fans are on/off. Finer adjustments to the amount of fog being distributed are controlled with dampers where pipes 141 branch off into specific locations. Dampers at each location enable the right amount of fog to be delivered to a specific environment and using the highest humidity requirement to turn foggers and fans on/off guarantees that fog will be available. Piping carrying fog can be located above, below, behind, or inside of the plenum. An additional pipe with a damper 146 allows excess fog to fill a condensation chamber 134 and returns the condensate to the reservoir 132. Within the piping, there is optional UV lighting 122 for fog sterilization and cleaning. In one embodiment, Each 2-3-foot section of the plenum has a fog outlet located at the top and in front of the plenum ventilation holes. Adjacent to the fog outlet is a second outlet which connects to a duplicate set of pipes oriented as a mirror image of the fog pipes. The second set of pipes, instead of leading back to a water reservoir, lead to a reservoir for nutrients or additives.

The system of FIG. 2B relies on generation and delivery of fog and air into subsections of a plenum system, with subsections defined as logical sections of a vertical rack hydroponic system as a plant tray or a collection of channels (ebb and flow or NFT) or in a vertically oriented tower system as a collection of channels.

Fog outlets, whether attached to the water reservoir or the additive reservoir can be connected to funnel fog to the root compartments of plant growing trays to deliver fog (water and/or additives) directly to plant roots. Additives may include nutrients, plant growth stimulators and others. Connectors that funnel fog types directly into plant root zones may be funnel shaped, round pipes or they may be shaped like hair dryer attachments such as diffusers or straightener attachments to further localize the fog application. Larger attachments may be connected over the entire plenum section directing both air flow and fog to plant roots.

In embodiments, attachments may attach directly to a plenum or to a jetway style dock attached to the plenum and may use a planting inlet to deliver fog. In embodiments using a jetway-style docking station, attachments may clip into a plenum. Connectors such as customized spring clips (See FIG. 2D) can attach to the plenum docking station and enable attachment over the whole plenum section that narrows to funnel air flow to plant roots. In an alternative embodiment, instead of connectors attaching to plenum docking stations, lids can be added to plant trays and connected directly into the plenum docking station, for example for the purposes of specialty mushroom growing.

To grow specialty mushrooms, in one embodiment, culture bags and containers can be positioned in plant trays such as drain trays which are designed to sit on shelves of a rack. Such trays can include a lid that is open only at the plenum end and docking to the plenum. In some versions, the jetway style docking attachment connecting the plenum to the lid includes a solid-state cooling device enabling a drop in temperature for the air being blown into the mushroom fruiting environment. In other versions the solid-state cooling device is attached directly to or integrated into the plenum. To modify the microenvironment, such as to signal pinning or fruiting, the system can deliver an appropriate air flow to bring oxygen and/or clear CO2, and uniform laminar flow of fog and/or additives to mushroom cultures to create the right conditions for fruiting. Air speed will increase to the optimum amount, fog will begin to flow laminarly to boost the relative humidity and the solid-state device will turn on to cool the environment (See FIG. 2E). Additives for mushroom growing may include flavorings, nutrients, and the like.

To support mushroom growth in one embodiment docking stations can have a solid state cooling device such that when air from the plenum blows fog into the growing volume of the lid and tray containing mushroom culture bags, the air is cooled compared to ambient. Alternatively, a solid state cooling device may be attached directly to or integrated into the plenum itself.

With reference to FIGS. 4A and 4B, the laminar fog and air flow system 120 is designed to make it easy to grow mushrooms or plants interchangeably in any indoor growing environment. To support the growth of mushrooms in a conventional hydroponic set-up for plants, the laminar fog and air flow system 120 was developed and tested in an ebb and flow indoor growing system that was being used to grow various crop plants to early seedling stage (microgreens) and mature stages (beets, radish, lettuces, and kale). Once the laminar fog and air flow system 120 was installed, shelf positions (subsections) were easily changed over to grow mushrooms or continued as plant growing subsections. In addition to producing mushrooms anywhere in the system, we carried out tests to characterize the system. In FIGS. 4A and 4B lidded containers (on bottom shelf) contain mushrooms in the colonization phase. Every level, shelf, and sub-shelf in FIGS. 4A and 4B can interchangeably grow mushrooms and plants because of the laminar fog and air flow system 120.

With reference to FIG. 4C, a fog delivery mechanism of a pipe to channel fog directly to roots is shown. A tested germination rate based on FIG. 4C setup was 100% for both fogponics and a control ebb and flow setups.

With reference to FIG. 4F, a setup for system 120 is shown that supports many plants, and mushrooms (upper right of figure), and supporting both ebb and flow based plant growth (left and below right) as well as fogponics plant growth (right center)

With reference to FIG. 4K radishes are shown with kale seedlings in the back that were grown by an embodiment of system 120. FIG. 4L shows a side view of ducting and plenums supporting plant growth. FIG. 4H, 4I, show pathways 150 and 4J shows pathways 140 for an embodiment of system 120. FIGS. 4M, 4N, 4O, and 4P show various grown crops, which include beets, kale, beetroot, romaine lettuce, and radishes.

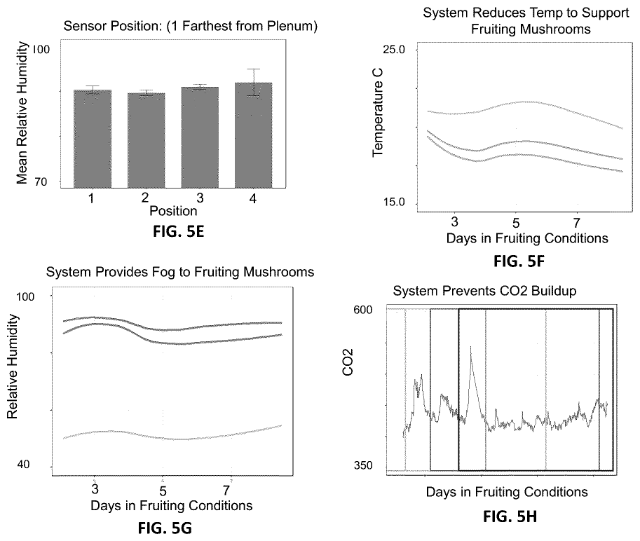

With Reference to FIGS. 5A, 5B, and 5C are charts for fog movement for fogponics delivery of water and nutrients to plant roots and germinating seeds. The charts track the movement of fog through the growth trays 112 in a subsection of a shelf to support germination and growth of plants. Since germinating seeds and early-stage plants prefer very low air speeds and are easily desiccated, we aimed to determine whether the gentle filling of a subsection in a shelf as provided by the fog generation fans would be sufficient. In the embodiment tested here, fog is gently moved through the pipes only and not exposed to the plenum. Tray 4 represents a tray that is closest to the fog outlet and Tray 1—root zone was the location for the sensor that switches fog off and on based on a setpoint of 80% for Relative Humidity. Times A (see FIG. 5A), B (see FIG. 5B) and C (see FIG. 5C) were recorded in succession and demonstrate the fog filling the entire space. Fog moves throughout the space starting in the back (Time A, Tray position 4) and expands further into the middle spaces (Time B, Tray positions 2, 3 and 4). By the time fog expands into the front of the tray (Time C, Tray positions 1 and 2), the humidity gradient is reversed from the starting position. All positions were able to maintain sufficient humidity to support germinating seedlings. In summary, the system 120, per charts of FIGS. 5A, 5B, and 5C, efficiently delivers fog to plant roots and to germinating seeds.

FIG. 5D shows different seedlings germinated using the system's (120) fogponics capability, which showed growth stage progression. Seedling development in fogponics of FIG. 5D for Breen Romaine lettuce showed good progression with some seedlings at the three- or four-leaf stage around 10-12 days after sowing.

FIG. 5E shows levels of humidity in trays as impacted by location of a crop within a tray and by sensor location. That is, in accordance with one system 120 arrangement, we set out to determine the best sensor location for plant germination and seedling growth using the laminar fog and airflow system 120 for fogponics. The planting space of the sub-shelf (112) was mapped, identifying eight positions total in the four containers 110. Position 1 was farthest from the plenum and Position 4 was closest and within each container 110 we mapped a left or A position and a right, B position. The controller humidity sensor was positioned in position A of each container 110 in turn and location and humidity was recorded for the other positions using different sensors. We observed that the position farthest from the plenum was the best position for maintaining humidity in a uniform way. Controller location 1A, maintained a higher average humidity for all Tray positions with minimal variability. From this work, it is preferable that humidity sensors are in a position farthest from the fog outlet into the root zone.

FIG. 5F shows a chart where fruiting starts for a fruiting mushroom. Per the chart, the system maintains a lower temperature compared to a colonization phase or compared to ambient. Lower temperature can be key to signaling the mycelium to fruit. That is, mycelium running (colonization of growth substrate) occurs at ambient temperatures. A slight decrease in temperature signals the mycelium to initiate fruiting. A drop of a few degrees compared to the colonization stage is often all that is needed. Here the drop in temperature and maintenance of the reduced temperature for the desired period, has been enabled by running a temperature reduction device (solid state cooling device) that is attached or integrated into the plenum wall. In the chart's readings, sensors were placed in the front and back of the mushroom fruiting tray 112 and just outside of the fruiting area to track temperature. During the fruiting process the needed temperature was maintained.

FIG. 5G shows relative humidity against days in a fruiting conditions for fruiting mushrooms grown per arrangements of system 120. Mushrooms consist mostly of water, and generally need a humidity level above 80%. In the tests charted here, relative humidity was maintained above 80 for fruiting mushrooms. In the system, fog was generated by ultrasonic fogger discs in reservoirs and fans were used to move the fog through a series of pipes to an environment that was separated by a simple barrier in the form of a plastic lid. Sensors were placed in the front and back of the enclosure to monitor humidity during the fruiting period. Fog, delivered by the system, maintained humidity throughout the fruiting period and enabled the production of mushrooms. Though the humidity in the fruiting tray 112 followed similar large trends as ambient temperature (bottommost line), these did not take the humidity out of range. The chart shows that fruiting mushrooms are well supported by the system 120.

FIG. 5H is a chart tracking CO2 during mushroom fruiting, which revealed high periods of CO2 release during fruiting body expansion. Mushrooms use oxygen during fruit expansion and exhale CO2. Fresh air helps stimulate mushroom production and is essential to prevent CO2 from accumulating in the environment. Ideally, in a mushroom fruiting environment CO2 will be maintained lower than 800 ppm during the fruiting cycle. In this investigation of a system 120 embodiment, CO2 sensors were placed in the plant tray as previously described and CO2 was recorded in 15-minute increments. Mushroom fruiting was monitored daily to identify the beginning and end of the fruiting period. The system demonstrates the ability to prevent accumulation of CO2 for fruiting mushrooms. As can be seen. the highest CO2 peak occurred on day 4 when all four batches of mushrooms were fruiting at the same time, but even this peak was under 550 ppm.

### Systems, Devices and Operating Systems

As previously noted, system 120 can be controlled by a computing device 118, which also receives relevant information and is able to generate relevant report. In one embodiment, reports like those shown in FIGS. 5A, 5B, 5C, 5D, 5E, 5F, 5G, and 5H are able to be displayed and/or printed by device 118. Applications, designed to run on desktops, servers, and even mobile phones, can be used to interact with system 120. For example, in one embodiment, a user-friendly app enables manual and automated control over the system and tracking of microenvironments. All dampers provide manual or automated adjustment throughout the ducting, pipes, and plenums. Sensors for each subsection monitor air speed, relative humidity, temperature, and CO2.

Control system software and app enable users to enter start dates for biological material for scheduling and tracking. In this manner users can generate recipes to automate the control of environmental conditions. For example, a user could create a recipe such as setting the system to start sending fog to mushroom culture on day fourteen after inoculation and to maintain 80 percent RH.

In general, device 118 and its software/application includes numerous features including, but not limited to environmental setpoint recipes and alerts, tracking and scheduling of activities, user recipe setting and recipe-based adjustments, real-time humidity monitoring and fog and/or additive production adjustment, real-time airspeed monitoring and adjustment, and rack and shelf, or tower subsection-specific (e.g., 3-foot subsection) temperature adjustment. A backend infrastructure used in conjunction with system 120 can include cloud-based data storage and synchronization and RESTful APIs for third-party integrations. In one embodiment, the software platform used for system 120 can leverage the Ag Data Application Programming Toolkit (ADAPT) standards, which is an open source project. The ADAPT standards facilitate interoperability between a multitude of different software and hardware applications.

With regards to security, end-to-end encryption can exist for data transmissions. Further, the system's software can use secure boot and signed firmware updates to minimize root-kit vulnerabilities. In embodiments, logging onto software via the network 113 can require two-factor authentication.

A mobile app used with system 120 can be compatible with IOS, ANDROID, and the like and may be published on the respective OS app stores for easy downloading. BLUETOOTH and WIFI connective options are both enabled for mobile devices in embodiments. The mobile software has user authentication and account management features, which can be enabled for business entities.

Hardware integration in embodiments can preferably utilize the Message Queuing Telemetry Transport (MQTT) protocol for device-app integration. Sensor integration exists for temperature, humidity, CO2, damper status, water levels, fan state, and the like. In embodiments, various ones of the sensors of sets thereof can be internet of things (IoT) sensors compliant to IoT protocols.

Additional software/platform features in embodiments include:
1. Multi-crop: The laminar air and fog delivery system with optional air/fog cooling enables multi-cropping plants and fungi (in a vertical or horizontal growing format), within separate microenvironment or within the same microenvironment.
2. Scaling one crop relative to the other (to adjust the mix of end products).
3. Supplies the needed air flow and fog with optional air/fog cooling (to fungi, microgreens, and mature crop plants).
4. Fog is delivered in a horizontal ‘laminar’ movement (to achieve controlled distribution across the growing volume). Or vertical flow for a tower
5. Air is adjustably delivered into the growing environment
6. Targeted delivery of fog (to plant or mushroom morphology).
7. Delivery of varied nutrients or additives (to targeted morphology by crop).
8. Adjustable air/fog temperature (to enhance fruiting in mushrooms).
9. Control system and app for automated or manual adjustment.

At a lower level of granularity, a basic configuration of a computing device is illustrated in FIG. 3 by those components within the inner dashed line. In the basic configuration of the computing device 336, the computing device 336 includes a processor 334 and a system memory 312. The terms “processor” and “central processing unit” or “CPU” are used interchangeably herein. In some examples, the computing device 336 may include one or more processors and the system memory 332. A memory bus 312 is used for communicating between the one or more processors 334 and the system memory 332.

Depending on the desired configuration, the processor 334 may be of any type, including, but not limited to, a microprocessor (μP), a microcontroller (μC), and a digital signal processor (DSP), or any combination thereof. In examples, the microprocessor may be AMD's ATHLON, DURON, and/or OPTERON; ARM's application, embedded and secure processors; IBM and/or MOTOROLA's DRAGONBALL and POWERPC; IBM's and SONY's Cell processor; INTEL'S CELERON, CORE (2) DUO, ITANIUM, PENTIUM, XEON, and/or XSCALE; and/or the like processor(s).

Further, the processor 334 may include one more levels of caching, such as a level cache memory 326, a processor core 324, and registers 322, among other examples. The processor core 324 may include an arithmetic logic unit (ALU), a floating point unit (FPU), and/or a digital signal processing core (DSP Core), or any combination thereof. A memory controller 318 may be used with the processor 334, or, in some implementations, the memory controller 318 may be an internal part of the memory controller 318.

Depending on the desired configuration, the system memory 332 may be of any type, including, but not limited to, volatile memory (such as RAM), and/or non-volatile memory (such as ROM, flash memory, etc.), or any combination thereof. The system memory 332 includes an operating system 330, one or more engines, such as an engine 320, and program data 314. In some embodiments, the engine 320 may be an application, a software program, a service, or a software platform, as described infra. The system memory 332 may also include a storage engine 316 that may store any information of data disclosed herein.

The operating system 330 may be a highly fault tolerant, scalable, and secure system such as: APPLE MACINTOSH OS X (Server); AT&T PLAN 9; BE OS; UNIX and UNIX-like system distributions (such as AT&T's UNIX; BERKLEY SOFTWARE DISTRIBUTION (BSD) variations such as FREEBSD, NETBSD, OPENBSD, and/or the like; Linux distributions such as RED HAT, UBUNTU, and/or the like); and/or the like operating systems. However, more limited, and/or less secure operating systems also may be employed such as APPLE MACINTOSH OS, IBM OS/2, MICROSOFT DOS, MICROSOFT WINDOWS 2000/2003/3.1/95/98/CE/MILLENNIUM/NT/VISTA/XP (Server), PALM OS, and/or the like. The operating system 330 may be one specifically optimized to be run on a mobile computing device (e.g., one configuration for device 118), such as iOS, ANDROID, WINDOWS Phone, TIZEN, SYMBIAN, and/or the like.

As explained supra, the GUI may provide a baseline and means of accessing and displaying information graphically to users. The GUI may include APPLE MACINTOSH Operating System's AQUA, IBM's OS/2, Microsoft's WINDOWS 2000/2003/3.1/95/98/CE/MILLENNIUM/NT/XP/Vista/7 (i.e., AERO), UNIX'S X-Windows (e.g., which may include additional UNIX graphic interface libraries and layers such as K DESKTOP ENVIRONMENT (KDE), MYTHTV and GNU Network Object Model Environment (GNOME)), web interface libraries (e.g., ActiveX, AJAX, (D) HTML, FLASH, JAVA, JAVASCRIPT, etc. interface libraries such as, but not limited to, DOJO, JQUERY (UI), MOOTOOLS, PROTOTYPE, SCRIPT.ACULO.US, SWFOBJECT, or YAHOO! User Interface, any of which may be used.

Additionally, a web browser component (not shown) is a stored program component that is executed by the CPU. The web browser may be a conventional hypertext viewing application such as MICROSOFT INTERNET EXPLORER, EDGE, CHROME, FIREFOX, or NETSCAPE NAVIGATOR. SECURE WEB browsing may be supplied with 128 bit (or greater) encryption by way of HTTPS, SSL, and/or the like. Web browsers allowing for the execution of program components through facilities such as ACTIVEX, AJAX, (D) HTML, FLASH, JAVA, JAVASCRIPT, web browser plug-in APIs (e.g., FIREFOX, SAFARI Plug-in, and/or the like APIs), and/or the like. Web browsers and like information access tools may be integrated into PDAs, cellular telephones, and/or other mobile devices.

A web browser may communicate to and/or with other components in a component collection, including itself, and/or facilities of the like. Most frequently, the web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a web browser and an information server, a combined application may be developed to perform similar functions of both. The combined application would similarly affect the obtaining and the provision of information to users, user agents, and/or the like from the enabled nodes of the present invention.

Moreover, the computing device 336 may have additional features or functionality, and additional interfaces to facilitate communications between the basic configuration and any desired devices and interfaces. For example, a bus/interface controller is used to facilitate communications between the basic configuration and data storage devices via a storage interface bus 302. The data storage devices may be one or more removable storage devices, one or more non-removable storage devices, or a combination thereof. Examples of the one or more removable storage devices and the one or more non-removable storage devices include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus facilitates communication from various interface devices (e.g., one or more output devices 338, one or more peripheral interfaces 346, and one or more communication devices 354) to the basic configuration via the bus/interface controller 310. Some of the one or more output devices 338 include a graphics processing unit 340 and an audio processing unit 344, which are configured to communicate to various external devices, such as a display or speakers, via one or more A/V ports 342.

The one or more peripheral interfaces 346 may include a serial interface controller 350 or a parallel interface controller 352, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 348.

Further, the one or more communication devices 354 may include a network controller 356, which is arranged to facilitate communication with one or more other computing devices 360 over a network 210 communication link via one or more communication ports 358. The one or more other computing devices 360 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 332, the one or more removable storage devices 304, and the one or more non-removable storage devices 306 are examples of the computer-readable storage media. The computer-readable storage media is a tangible device that can retain and store instructions (e.g., program code) for use by an instruction execution device (e.g., the computing device 336). Any such, computer storage media is part of the computing device 336.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer-readable instructions are provided to the processor 334 of a general purpose computer, special purpose computer, or other programmable data processing apparatus (e.g., the computing device 336) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 336), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages (e.g. Python). The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A fog and air flow system comprising:
a fogger configured to produce fog used for indoor crop growth per fogponics, wherein the fogger is configured to customize characteristics of the fog including a composition of nutrients carried within in accordance with growth needs of different crop types, which includes a first fog configuration for a first crop and a second fog configuration for a second crop;
flow pathways configured to transport fog created by the fogger to a first crop surface and to a second crop surface; and
airflow components configured to direct a flow of air, which affects movement of fog created by the fogger, wherein the fog and airflow system is configured to:
direct a first laminar flow of air resulting in movement of the first fog across the first surface containing the first crop; and
direct a second laminar flow of air resulting in movement of the second fog across the second surface containing the second crop, wherein each of the first and second laminar flows have a controlled velocity and direction such that each flow occur in a substantially planar fashion.

2. The system of claim 1, wherein the first surface is proximate to the second surface such that a turbulent movement of fog as opposed to that resulting from the first and second laminar flows would result in a significant amount of the first fog being absorbed by the second crop and a significant amount of second fog being absorbed by the first crop, wherein the first crop is not substantially exposed to the second fog, wherein the second crop is not substantially exposed to the first fog.

3. The system of claim 1, wherein the second crop would be adversely affected by the first fog were the first laminar flow a turbulent movement instead of being a laminar one, wherein the first crop would be adversely affected by the second fog were the second laminar flow a turbulent flow instead of being a laminar one, wherein the first crop is not adversely affected by the second flow, wherein the second crop is not adversely affected by the first fog.

4. A method that applies laminar flows of fog to controlled environment agriculture (CEA) comprising:
establishing an indoor farm unit comprising:
a plurality of growth surfaces, comprising at least a first surface and a second surface, wherein a first crop of a first crop type grows on the first surface, wherein a second crop of a second crop type grows on the second surface;
applying, via a CEA system configured to customize environmental growth conditions for crops through a selective application of system configurable fog, first fog adjustments for the first crop;
applying second fog adjustments for the second crop;
directing a first laminar flow of a first fog consistent with the first fog adjustments across the first surface; and
directing a second laminar flow of a second fog consistent with the second fog adjustments across the second surface, wherein despite the first crop being relatively proximate to the second crop, the first laminar flow of the first fog does not appreciably affect the second crop and the second laminar flow of the second fog does not appreciably affect the first crop, wherein the second crop would be adversely affected by the first fog were the first laminar flow a turbulent air movement instead of being a laminar one, wherein the first crop would be adversely affected by the second fog were the second laminar flow a turbulent air movement instead of being a laminar one.

5. The method of claim 4, wherein the first crop adjustments comprise a first fog temperature, a first fog nutrient mix, and a first fog humidity level, and wherein the second crop adjustments comprise a second fog temperature, a second fog nutrient mix, and a second fog humidity level.

6. The method of claim 5, wherein the first crop is a plant, wherein the second crop is a fungus.

7. The method of claim 5, wherein the first fog adjustments, which are optimized for the first crop, wherein the second fog adjustments are optimized for the second crop.

8. The method of claim 5, wherein the first surface and the second surface are substantially parallel surfaces separated by a perpendicular distance D, wherein D is less than a distance across the first surface traveled by the first fog.

9. The method of claim 5, wherein each of the growth surfaces are substantially horizontal surfaces, wherein the first and second laminar flows are planar flows traveling along a substantially horizontal plane.

10. The method of claim 5, wherein each of the growth surfaces are substantially vertical surfaces, wherein the first and second laminar flows are planar flows traveling along a substantially vertical plane.

11. The method of claim 5, wherein the first crop and the second crop are not separated by an air or water tight barrier.

12. The method of claim 5, wherein the indoor farm unit is a rack, which is a shelving unit comprising a plurality of vertically stacked shelves, each supporting a crop tray, wherein the first surface is a first shelf of the plurality of vertically stacked shelves, wherein the second surface is a second shelf of the plurality of vertically stacked shelves.

13. A controlled environment agriculture (CEA) system for applying laminar movements of air and fog comprising:
a plurality of crop growth surfaces comprising at least a first surface and a second surface, each of the crop growth surfaces being a tunable microenvironment, wherein a first crop of first crop type grows on the first surface, wherein a second crop of a second crop type grows on the second surface;
a fogger configured to produce fog of configurable compositions, wherein said fog carries nutrients and water needed for crop growth at configurable temperatures, wherein a first fog configuration for a first fog is optimized for growth conditions of the first crop type, wherein a second for configuration for a second fog is optimized for growth conditions of the second crop type;
flow pathways configured to direct fog produced by the fogger through a first pathway to the first surface and configured to direct fog produced by the fogger through a second pathway to the second surface; and
airflow components configured to increase or decrease a flow of air being conveyed through the flow pathways to the first surface and to the second surface, wherein the CEA system is configured to:
direct a first flow of the first fog across the first surface via laminar movement; and
direct a second flow of the second fog across the second surface via a laminar movement,
wherein despite the first crop being relatively proximate to the second crop, the first flow of the first fog does not appreciably affect the second crop and the second flow of the second fog does not appreciably affect the first crop.

14. The CEA system of claim 13, wherein the first crop is a plant, wherein the second crop is a fungus, wherein the second crop would be adversely affected by the first fog were the first flow a turbulent and not a laminar one, wherein the first crop would be adversely affected by the second fog were the second flow a turbulent and not a laminar one.

15. The CEA system of claim 13, wherein the first surface and the second surface are substantially parallel surfaces separated by a perpendicular distance D, wherein D is less than a distance across the first surface traveled by the first fog.

16. The CEA system of claim 13, wherein each of the growth surfaces are substantially horizontal surfaces, wherein the first and second laminar flows are planar flows traveling along a substantially horizontal plane.

17. The CEA system of claim 13, wherein each of the growth surfaces are substantially vertical surfaces, wherein the first and second laminar flows are planar flows traveling along a substantially vertical plane.

18. The CEA system of claim 13, wherein the flow pathways comprise a set of pipes, ducting, and outlets.

19. The CEA system of claim 13, wherein the airflow components comprise at least one pump and a plurality of fans.

20. The CEA system of claim 13, further comprising a plurality of sensors, said sensors comprising at least one temperature sensor, at least one CO2 sensor, at least one humidity sensor, and at least one airflow sensor.
